(19) United States
(12) Patent Application Publication
(10) Pub. No.: US 2025/0300591 A1
(43) Pub. Date: Sep. 25, 2025

(54) DOUBLE GLAZED LOUVER WINDOW WITH PHOTOVOLTAIC LOUVER STRUCTURES

(71) Applicant: UNICEL ARCHITECTURAL CORP., Longueuil (CA)

(72) Inventors: Vincent COUTURIER, Longueuil (CA); Samuel DOYON-BISSONNETTE, Longueuil (CA); Efstratios Dimitrios ROUNIS, Longueuil (CA)

(21) Appl. No.: 19/087,369

(22) Filed: Mar. 21, 2025

Related U.S. Application Data
(60) Provisional application No. 63/567,978, filed on Mar. 21, 2024.

(51) Int. Cl. H02S 20/22; E06B 9/24; E06B 9/264; E06B 9/386

(52) U.S. Cl. CPC H02S 20/22; E06B 9/264; E06B 9/386; E06B 2009/2476; E06B 2009/2643

(57) ABSTRACT

A louver-blind double glazed window unit comprises a frame structure with spaced apart inner and outer windows mounted thereto defining an inner chamber therein. A plurality of louver structures extend within the chamber and are pivotally mounted to the frame. Each louver structure comprises a respective photovoltaic stream. An electrical circuit comprises positive and negative contact members respectively positioned at respective longitudinal ends of the louver member and being in contact with the photovoltaic cell stream. The electrical circuit comprises positive and negative wires within a channel defined by the louver member and being in electrical communication with the positive and negative contact members respectively via openings in the louver member. The louver member comprising a pivot member for being pivotally mounted to a longitudinal part of the frame structure and for receiving therein the positive and negative wires to protrude therefrom for electrical communication with an electrical circuit load.

### CROSS-REFERENCE TO RELATED APPLICATIONS

The present application claims priority on U.S. Provisional Patent Application Ser. No. 63/567,978 filed on Mar. 21, 2024, and incorporated by reference herein in its entirety.

### TECHNICAL FIELD

The present disclosure generally relates to a louver blind structure in a double-glazed window unit. More particularly, but not exclusively, the present disclosure relates to a louver structure with photovoltaic louver structures.

### BACKGROUND

Louver blind structures are well known in the art. These structures are located within the inner chamber of a window unit and include a plurality of louver members or slat members which are equally spaced and horizontally disposed. The louver member can pivot from a vertical position slightly overlapping one another to form a uniform vertical surface that blocks light from streaming therethrough. The louver members can also be pivoted into a horizontal position in order to let light pass between adjacent and spaced apart louver members. The actuation systems for causing louvers of a louver blind structure to pivot between open and closed positions include a gear system mechanically in contact with the louvers and connected to outer control such as a tilt rod, a switch and the like.

### OBJECTS

It is an object of the present disclosure to provide a louver blind structure.

It is an object of the present disclosure to provide louver blind structure in a double-glazed window unit.

It is an object of the present disclosure to provide a kit for a louver blind structure.

### SUMMARY

In accordance with an aspect of the disclosure there is provided a louver-blind double glazed window unit comprising: a frame structure defining first and second faces of the unit, and outer side and inner sides; a first window mounted to the first face of the unit and a second window mounted to the second face of the unit, an inner chamber defined between the frame structure and the first and second windows; a plurality of adjacent louver structures longitudinally extending within the chamber and pivotally mounted to a longitudinal part of the frame structure, each one of the louver structures comprising: a longitudinal louver member defining a length thereof, a top side, an underside, an inner channel therebetween and a pair of opposite longitudinal ends, each of the pair of opposite longitudinal ends respectively defining a gear end and a pivot end, the longitudinal louver member comprises a pivot member at the pivot end pivotally mounted to the longitudinal part of the frame structure, the pivot member defining a pivot channel therethrough and pivot openings; a photovoltaic cell stream mounted to the top side of the louver member and comprising longitudinal a bus bar stream longitudinally extending along the length of the longitudinal louver member; and an electrical circuit in electrical communication with the photovoltaic cell stream, the electrical circuit comprising: a positive contact member mounted at one of the opposite longitudinal ends onto the photovoltaic cell stream and being in contact with a positive wire positioned within the longitudinal louver member channel via an opening in the top side of the longitudinal louver member, the positive wire being fitted within the pivot channel and protruding outwardly therefrom via one of the pivot openings to be in electrical communication with an electrical load circuit; and a negative contact member mounted at another of the opposite longitudinal ends onto the photovoltaic cell stream and being in contact with a negative wire positioned within the longitudinal louver member channel via an opening in the top side of the longitudinal louver member, the negative wire member being fitted within the pivot channel and protruding outwardly therefrom via one of the pivot openings to be in electrical communication with an electrical load circuit; and an actuator assembly in operative communication with the plurality of louver members at the gear ends thereof for selectively imparting a pivot movement thereto between open and closed positions thereof.

In accordance with an aspect of the disclosure there is provided a louver-blind structure for a double-glazed window unit comprising a frame structure defining first and second faces of the unit, and outer side and inner sides, a first window mounted to the first face of the unit and a second window mounted to the second face of the unit; and an inner chamber defined between the frame structure and the first and second windows, the louver-blind structure comprising: a plurality of adjacent louver structures longitudinally extending within the chamber and pivotally mounted to a longitudinal part of the frame structure, each one of the louver structures comprising: a longitudinal louver member defining a length thereof, a top side, an underside, an inner channel therebetween and a pair of opposite longitudinal ends, each of the pair of opposite longitudinal ends respectively defining a gear end and a pivot end, the longitudinal louver member comprises a pivot member at the pivot end pivotally mounted to the longitudinal part of the frame structure, the pivot member defining a pivot channel therethrough and pivot openings; a photovoltaic cell stream mounted to the top side of the louver member and comprising longitudinal a bus bar stream longitudinally extending along the length of the longitudinal louver member; and an electrical circuit in electrical communication with the photovoltaic cell stream, the electrical circuit comprising: a positive contact member mounted at one of the opposite longitudinal ends onto the photovoltaic cell stream and being in contact with a positive wire positioned within the longitudinal louver member channel via an opening in the top side of the longitudinal louver member, the positive wire being fitted within the pivot channel and protruding outwardly therefrom via one of the pivot openings to be in electrical communication with an electrical load circuit; and a negative contact member mounted at another of the opposite longitudinal ends onto the photovoltaic cell stream and being in contact with a negative wire positioned within the longitudinal louver member channel via an opening in the top side of the longitudinal louver member, the negative wire member being fitted within the pivot channel and protruding outwardly therefrom via one of the pivot openings to be in electrical communication with an electrical load circuit; and an actuator assembly in operative communication with the plurality of louver members at the gear ends thereof for selectively imparting a pivot movement thereto between open and closed positions thereof.

In an embodiment, a given one of the pivot members is positioned between a first and second adjacent ones of the pivot members along the longitudinal part of the frame structure, the negative wire protruding through the given one of the pivot members is connected to the positive wire protruding through the first adjacent one of the pivot members and the positive wire protruding through the given one of the pivot members is connected to the negative wire protruding through the second adjacent one of the pivot members.

In an embodiment, the negative wires protruding through the pivot members are connected to a same common negative wire and wherein the positive wires protruding through the pivot members are connected to a same common positive negative wire.

In an embodiment, the photovoltaic cell stream comprises a series of photovoltaic cells arranged along their length on the top side of each of the louver members and being spaced apart so as to define gaps therebetween, wherein the longitudinal bus bar stream comprises a bus bar on each top and bottom surface of each photovoltaic cell, wherein the bus bar at the top side of one of the photovoltaic cells is connected to the bus bar at the bottom side of an adjacent one of the photovoltaic cells via a contact member extending through the gap therebetween.

In an embodiment, the actuation assembly comprises a gear assembly mounted to the frame with an inwardly protruding member engaging an inner flat member engaging louver gears for imparting the pivot movement thereto between open and closed positions thereof.

In an embodiment, the actuation assembly is manually controlled or motorized.

In an embodiment, a controller is in operative communication with the actuation assembly for control thereof. In an embodiment, a sensor detects electrical output of the electrical circuit load and is in operative communication with the controller to provide electrical output data thereto, the controller having an associated memory of computer executable code for implementing computer steps of controlling the actuation assembly based on the electrical output data. In an embodiment, a sensor detects light capturing performance of the photovoltaic stream and electrical and being in operative communication with the controller to provide capturing performance thereto, the controller having an associated memory of computer executable code for implementing computer steps of controlling the actuation assembly based on the capturing performance data.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

The following drawings form part of the present specification and present disclosure. In the appended drawings:

FIG. 1 is a side and front perspective view of the louver-blind double glazed window unit showing the louvre blind structure thereof in a closed position in accordance with a non-restrictive illustrative embodiment of the present disclosure;

FIG. 2 is another side and front perspective view of the louver-blind double glazed window unit showing the louvre blind structure thereof in an open position in accordance with a non-restrictive illustrative embodiment of the present disclosure;

FIG. 3 is an exploded perspective view of a louver structure in accordance with a non-restrictive illustrative embodiment of the present disclosure;

FIG. 4 is a top view of a photovoltaic cell stream in accordance with a non-restrictive illustrative embodiment of the present disclosure;

FIG. 5 is an exploded perspective view of the photovoltaic cell stream of FIG. 4 in accordance with a non-restrictive illustrative embodiment of the present disclosure;

FIG. 6 is a top view of a louver structure in accordance with a non-restrictive illustrative embodiment of the present disclosure;

FIG. 7 is an inner bottom view of the louver structure of FIG. 6 in accordance with a non-restrictive illustrative embodiment of the present disclosure;

FIG. 8 is an inner top view of the louver structure of FIG. 6 in accordance with a non-restrictive illustrative embodiment of the present disclosure;

FIG. 9 is a transparent, perspective top and side view of the louver structure FIG. 6 in accordance with a non-restrictive illustrative embodiment of the present disclosure;

FIG. 10 is a transparent, perspective top and side view of the louver structure FIG. 6 showing the gear end portion thereof in accordance with a non-restrictive illustrative embodiment of the present disclosure;

FIG. 11 is an enlarged view of portion 11 in FIG. 7 in accordance with a non-restrictive illustrative embodiment of the present disclosure;

FIG. 12 is a transparent, perspective top and side view of the louver structure FIG. 6 showing the pivot end portion thereof;

FIG. 13 is a perspective view of the louver-blind double glazed window unit mounted to a building structure in accordance with a non-restrictive illustrative embodiment of the present description;

FIG. 14 is a side view of the unit of FIG. 13 in accordance with a non-restrictive illustrative embodiment of the present description;

FIG. 15 is the side view of FIG. 14 with a side panel thereof having been removed in accordance with a non-restrictive illustrative embodiment of the present description;

FIG. 16 is a top view of the unit of FIG. 13 in accordance with a non-restrictive illustrative embodiment of the present description;

FIG. 17 is the top view of FIG. 16 with a top panel thereof having been removed in accordance with a non-restrictive illustrative embodiment of the present description;

FIG. 18 is a top end, perspective, side and front view of the unit of FIG. 15 in accordance with a non-restrictive illustrative embodiment of the present description;

FIG. 19 is a bottom end, perspective, side and front view of the unit of FIG. 15 in accordance with a non-restrictive illustrative embodiment of the present description;

FIG. 20 is a bottom end, perspective, side and front view the unit of FIG. 14 in accordance with a non-restrictive illustrative embodiment of the present description;

FIG. 21 is a top end, perspective, side and front view the unit of FIG. 14 in accordance with a non-restrictive illustrative embodiment of the present description;

FIG. 22 a schematic illustration of photovoltaic louver blind structure having louver structures thereof electrically connected in series in accordance with a non-restrictive illustrative embodiment of the present description;

FIG. 23 a schematic illustration of photovoltaic louver blind structure having louver structures thereof electrically connected in parallel in accordance with a non-restrictive illustrative embodiment of the present description;

FIG. 24 is a perspective view the louver-blind double glazed window unit from the inside of a building structure when the unit mounted thereto in accordance with a non-restrictive illustrative embodiment of the present description;

FIG. 25 is a perspective view of the unit of FIG. 24 from outside a building structure when the unit mounted thereto in accordance with a non-restrictive illustrative embodiment of the present description;

FIG. 26 is an outer window frame perspective side view of the actuation assembly of the unit of FIG. 24 in accordance with a non-restrictive illustrative embodiment of the present description;

FIG. 27 is an inner window frame perspective view of the actuation assembly of the unit of FIG. 24 in accordance with a non-restrictive illustrative embodiment of the present description; and

FIG. 28 is a schematic representation of a system 130 for monitoring and controlling a photovoltaic louver blind structure in accordance with a non-restrictive illustrative embodiment of the present description.

### DETAILED DESCRIPTION

Generally stated and in accordance with an embodiment, there is provided a louver-blind double glazed window unit comprising a frame structure, a double-glazed window, a louver-blind structure and an actuator assembly.

The frame structure defines first and second faces of the unit, and outer side and inner sides.

The double-glazed window comprises a first window mounted to the first face of the unit and a second window mounted to the second face of the unit. An inner chamber is defined between the frame structure and the first and second windows.

The louver structure comprises a plurality of adjacent louver structures longitudinally extending within the chamber and being pivotally mounted to a longitudinal part of the frame structure.

Each one of the louver structures comprises a longitudinal louver member, a photovoltaic cell stream for capturing solar energy and an electrical circuit for conducting the captured energy towards a collection and storage system.

The longitudinal louver member defines a length thereof, a top side, an underside, an inner channel between the top side and the underside and a pair of opposite longitudinal ends. Each one of the pair of opposite longitudinal ends respectively defines a gear end and a pivot end. The longitudinal louver member comprises a pivot member at the pivot end pivotally mounted to the longitudinal part of the frame structure. The pivot member defines a pivot channel therethrough and pivot openings.

The photovoltaic cell stream is mounted to the top side of the louver member and comprises longitudinal a bus bar stream longitudinally extending along the length of the longitudinal louver member.

The electrical circuit is in electrical communication with the photovoltaic cell stream. The electrical circuit comprises a positive contact member and a negative contact member. The positive contact member is mounted at one of the opposite longitudinal ends onto the photovoltaic cell stream and is in contact with a positive wire positioned within the longitudinal louver member channel via an opening in the top side of the longitudinal louver member. The positive wire is fitted within the pivot channel and protrudes outwardly therefrom via one of the pivot openings. The negative contact member is mounted at another of the opposite longitudinal ends onto the photovoltaic cell stream and is in contact with a negative wire positioned within the longitudinal louver member channel via an opening in the top side of the longitudinal louver member. The negative wire member is fitted within the pivot channel and protrudes outwardly therefrom via one of the pivot openings.

The actuator assembly in operative communication with the plurality of louver members at the gear ends thereof for selectively imparting a pivot movement thereto between open and closed positions thereof.

A given pivot member is positioned between first and second adjacent pivot members along the longitudinal part of the frame structure.

The protruding negative and positive wires are in electrical communication with an electrical circuit load.

In an embodiment the electrical circuit load is defined by the negative wire protruding through the given pivot member being connected to the positive wire protruding through the first adjacent pivot member and the positive wire protruding through this given pivot member being connected to the negative wire protruding through the second adjacent pivot member.

In an embodiment, the electrical circuit load is defined by the negative wires protruding through the pivot members being connected to a same common negative wire and the positive wires protruding through the pivot members being connected to a same common positive negative wire.

The terms “first” and “second” are used herein interchangeably and only for description purposes to simply differentiate between the two adjacent pivot members that the given pivot member is positioned between.

In an embodiment, a double glazed window comprises a double glazed insulated unit.

In an embodiment, multiple louver-blind double glazed window units which define a façade or a skylight and are connected in series or parallel to form photovoltaic (PV) strings and arrays.

In an embodiment, the cells cover a greater portion of the width of the louver blind thereby correspondingly increasing photovoltaic capture. In an embodiment, the orientation of the bus bars provides for the foregoing.

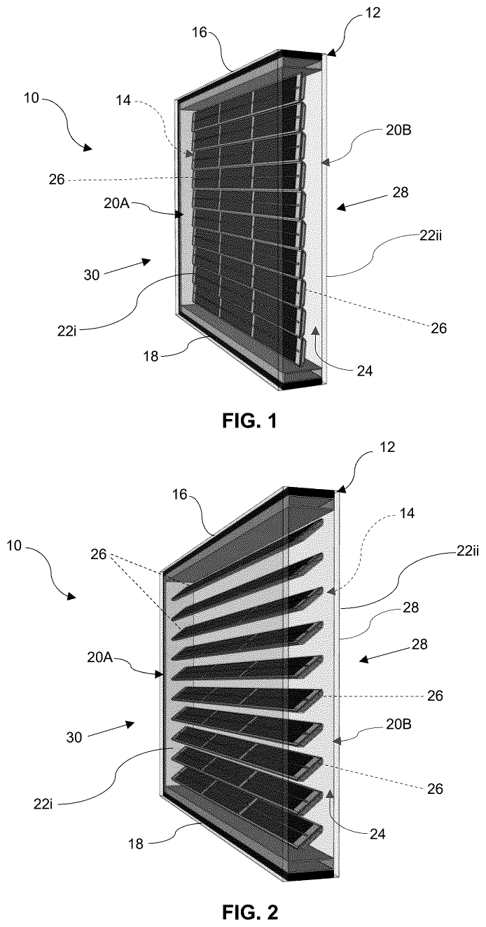

With reference to the appended Figures, non-restrictive illustrative embodiments will be herein described so as to further exemplify the disclosure only and by no means limit the scope thereof. FIGS. 1 and 2 show a double-glazed window unit 10 including a frame 12 with a louver blind structure 14 mounted thereto. The frame 12 has top and bottom members 16 and 18, respectively, and opposite lateral members 20A and 20B. The lateral member 20B in the example shown in FIGS. 1 and 2 is removed. First and second window panels or panes 22i and 22ii, respectively, are mounted to the frame 12 defining together with the frame 12 a chamber 24. In an embodiment, the 12 frame is attached to the two glass panes 22i, 22ii via primary and secondary sealant to form an insulated glazing unit.

The louver blind structure 14 includes a plurality of photovoltaic louver structures 26 positioned within the chamber 24 and extending horizontally between the spaced apart lateral members 20A and 20B and being pivotally mounted thereto so as to be moved between a closed position shown in FIG. 1 and an open position shown in FIG. 2. The double-glazed window unit 10 defines an inner face 28 forming part of the inner part of a building structure and an outer face 30 forming part of the outer part of this building structure. In this non-limiting example, the lateral member 20A defines the gear side of the unit 10 which contains the gear system for pivoting the louvers 26 whereas the lateral member 20B defines the pivot side. An example of a louver structure is described in U.S. Pat. No. 8,733,018 issued on May 27, 2014 and incorporated herein by reference in its entirety.

In another non-illustrated embodiment, the louvers 26 are vertical slats extending between the top and bottom members 16 and 18, respectively and being pivotally mounted thereto for being pivoted between open and closed positions. Accordingly, the double-glazed window unit 10 of the present disclosure provides for both horizontal and vertical louver members.

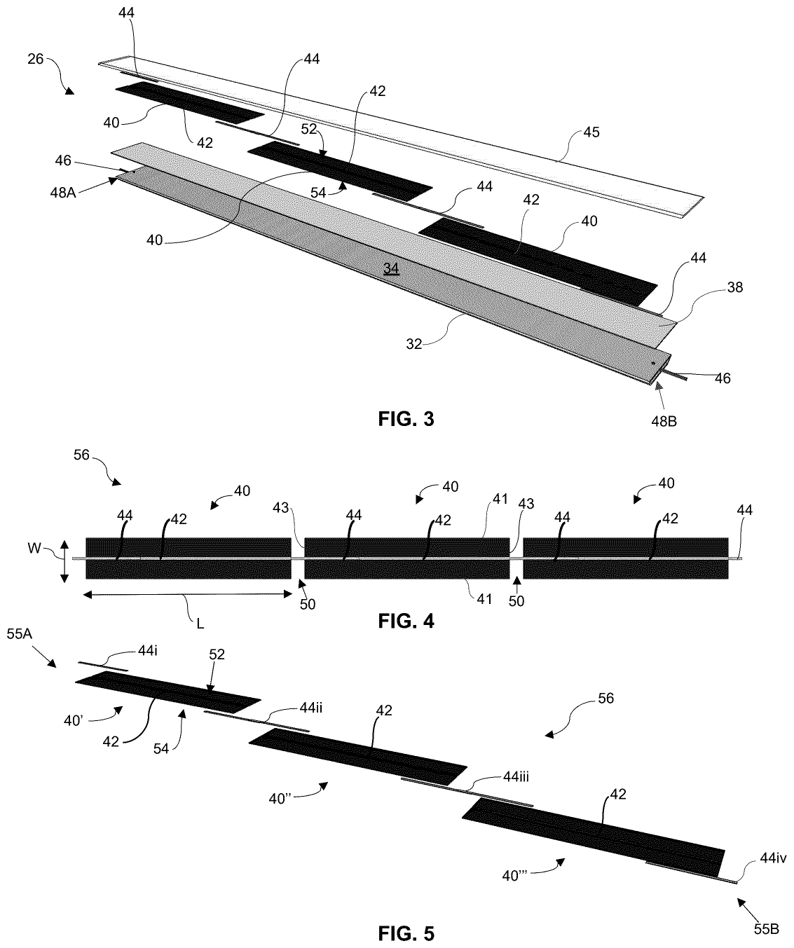

Turning now to FIGS. 3, there is shown an exploded view of a photovoltaic louver structure 26 comprising a longitudinal louver member 32.

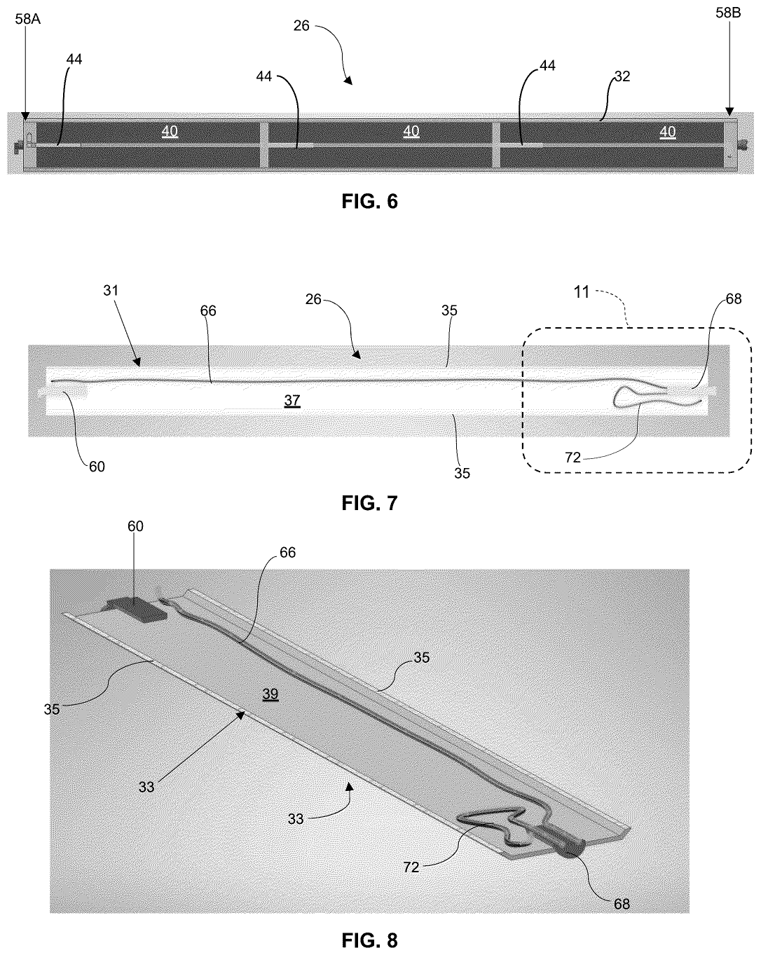

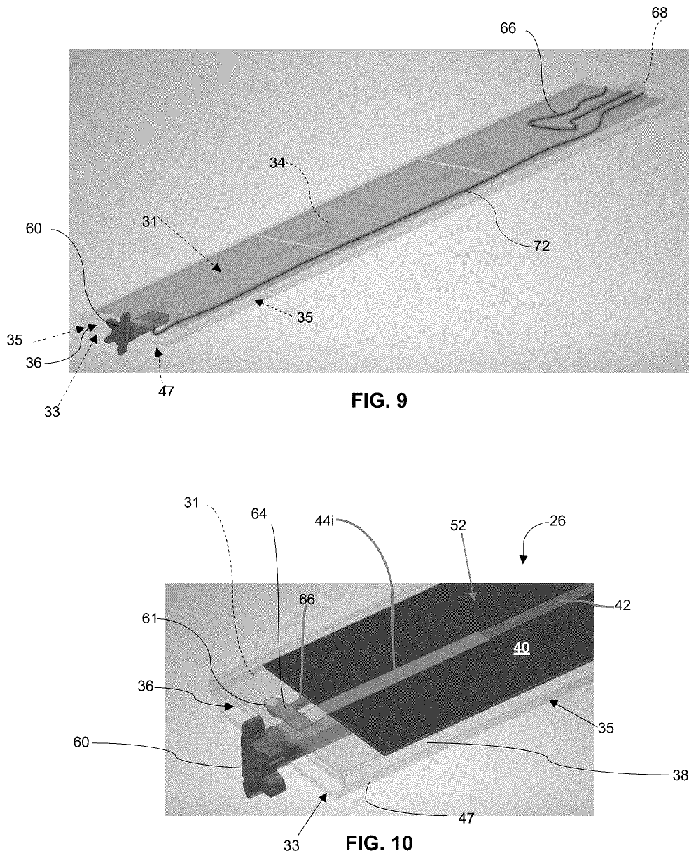

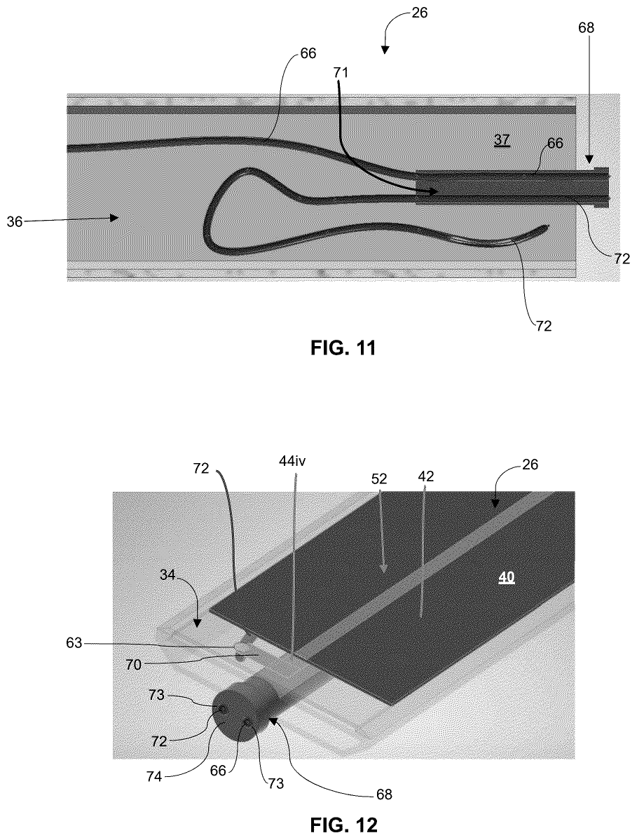

With particular reference to FIG. 9, the louver member 32 defines a top and bottom panels 31 and 33, respectively, being spaced apart and connected at the louver front and rear edges 35 to define an inner longitudinal channel 36. The top panel 31 defines a top outer surface 34 and an opposite undersurface 37 (see FIGS. 7 and 11). The bottom panel 33 defines an inner surface 39 (see FIG. 8) and an opposite outer surface 47. The channel 36 is formed between surfaces 37 and 39.

Turning back to FIG. 3, the top surface 34 receives a substrate 38 thereon on which photovoltaic cells 40 are laminated. In an embodiment, the cells 40 are cut strips of semiconductor material (e.g. silicone such as crystalline or thin-film, or other materials like cadmium telluride and copper indium gallium selenide etc.). Each cell 40 defines top and bottom surfaces 52 and 54. Each cell 40 includes central bus bars 42 at its top bottom surfaces 52 and 54 respectively. Indeed, this configuration may be directly printed on the cell 40. The top surface 34 (with substrate 38) includes a plurality of cells 40 arranged thereon along their lengths L (see FIG. 4). The bus bars 42 of adjacent cells 40 are interconnected via bus bar contacts elements or connectors 44. The louver structure 26 may also include an encapsulation element 45. Positive and negative terminals, generally denoted 46, are positioned through the channel 36 and protrude outwardly of the open longitudinal ends 48A and 48B of the louver member 32.

In the embodiments, the terminals 46 are inwardly directed.

In an embodiment, the louver structure 26 comprises aluminum.

In an embodiment, the photovoltaic cells 40 are flexible thin strips of film. In an embodiment, the film comprises crystalline silicone. In an embodiment, the photovoltaic (PV) cells 40 can be either crystalline silicone cut-cells or thin film/flexible PV strips that extend the full length of the louver structure.

Turning to FIG. 4, the photovoltaic cells 40 are cut into rectangles defining a width W and a length L, with the length L being greater than the width W. The width W of the cells spans the width of the louver member 32. The cells 40 are cut such that the lines are along the long axis L and not perpendicular thereto. Thus, the cells 40 define long front and rear sides 41 and shorter lateral sides 43. The bus bars 42 are positioned along the length L of the cells 40. The cells 40 are positioned along the length of the louver member 32 between ends 48A and 48B with their shorter sides 43 adjacently interfacing as shown in FIG. 4 with small gaps 50 therebetween.

With reference to both FIGS. 4 and 5, each cell 40 has a top face 52 including a central bus bar 42 running along the length L thereof and bottom face 54 with a central bus bar 42 running along the length L thereof. The bus bar 42 of the bottom face 54 is not shown but is a mirror image of the top face 52 and as such, the top and bottom faces are defined only when positioning the cell 40 on the louver as faces 52 and 54 are mirror images of each other.

Starting from a first end 55A of the cell series or photovoltaic stream 56 and moving towards the second end 55B thereof, the first top contact element (top negative) 44i is connected to the top bus bar 42 on the top face 52 of the first cell 40′. The second contact element 44ii is connected to the bottom bus bar 42 on the bottom face 54 of the first cell 40′ and to the top bus bar 42 on the top face 52 of the second cell 40″. The third contact element 44iii is connected to the bottom bus bar 42 on the bottom face 54 of the second cell 40″ and to the top bus bar 42 on the top face 52 of the third cell 40′″. The fourth contact element 44iv is connected to the bottom bus bar 42 on the bottom face 54 of the second third cell 40′″ and defines the bottom positive contact.

The series of bar bus bars 42 define a bus bar stream that longitudinally extends along the length L of the top face 34.

In an embodiment, the cells are single pre-laminated and printed films that are adhesively mounted directly onto the top surface 34 of the louver member 32. As such, there are no gaps 50 as the cell 40 is a long contiguous film running along the length of the stop surface of the louver member 32.

In a further embodiment, the cell 40 is printed directly on surface 34.

Turning to FIG. 6, there is shown a top view of the louver structure 26 showing the photovoltaic cells 40 positioned in series along the louver member 32 and being interconnected via the contact members 44. The louver structure 26 defines a gear end 58A (including a gear 60) and pivot end 58B (including a pivot 68). The gear 60 and the pivot 68 are shown in FIGS. 7 to 12.

FIG. 7 is a bottom view of the inner surface 37 of top panel 31 of the louver member 32 opposite the top surface 34 of the top panel 31 and FIG. 8 is a top view of the inner surface 39 of the bottom panel 33 of the louver member 32 opposite the bottom outer surface 47.

With reference to FIG. 10, a hole 61 is opened though the top panel 31 at the gear end 58A (next to the gear 60) and a connector 64 is connected to the top negative contact element 44i (see also FIG. 5) and to a negative wire 66 via the hole 61. As previously explained, this negative contact element 44i is also connected to the bus 42 on the top surface 52 of the cell 40. The negative wire 66 runs within the channel 36 between the inner sides 37 and 39 of the top and bottom panels 31 and 33 respectively, from the gear end 58A towards the pivot end 58B to be fitted within a pivot member 68 at the pivot end 58B.

With reference to FIGS. 7 to 9 and 11-12 the bottom positive contact element 44iv (see also FIG. 5) is connected to a connector 70 at the top surface 34 of the top panel 31. As previously explained, the contact member 44iv is connected the bus 42 at the bottom surface 54 of the cell 40. The connector 70 is connected to a positive wire 72 through hole 63 through the top panel 31 at the pivot end 58B. The positive wire 72 is positioned within the chamber 36 and curves along the inner sides 37 and 39 to be fitted within the pivot member 68.

With reference to FIGS. 8, 11 and 12, the negative wire 66 and the positive wire 72 are positioned within a channel 71 defined by the pivot member 68 and protrude through holes 73 formed through the lateral end wall 74 of the pivot member 68.

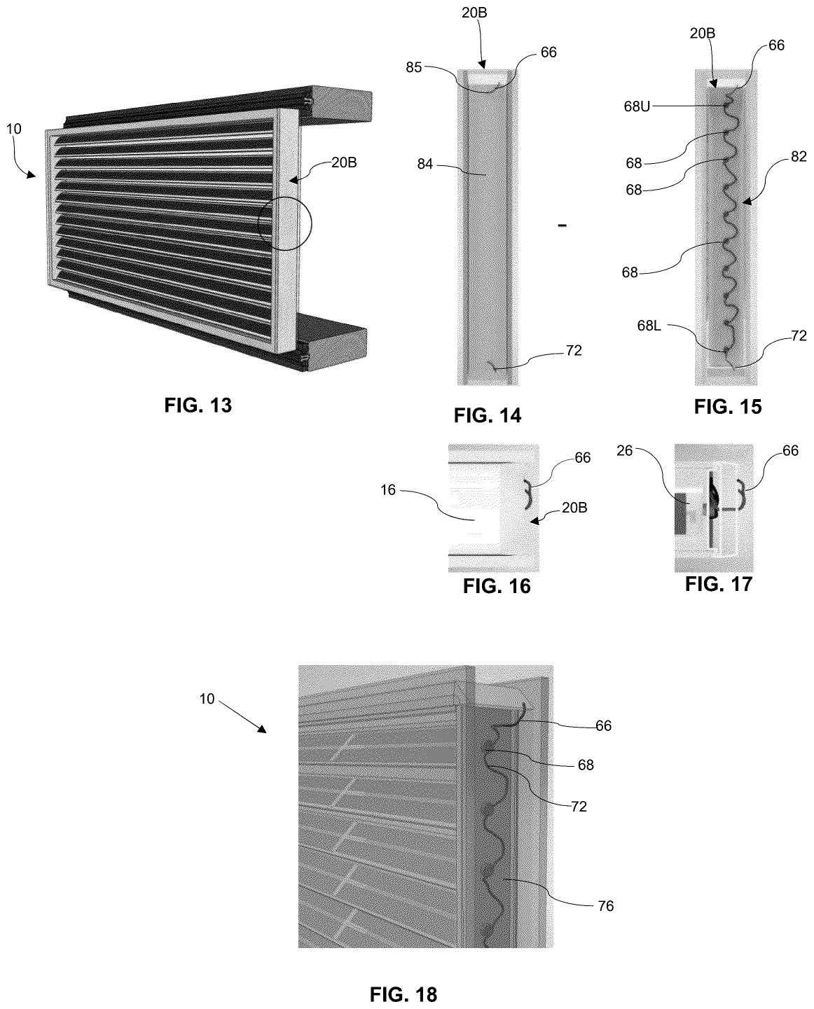

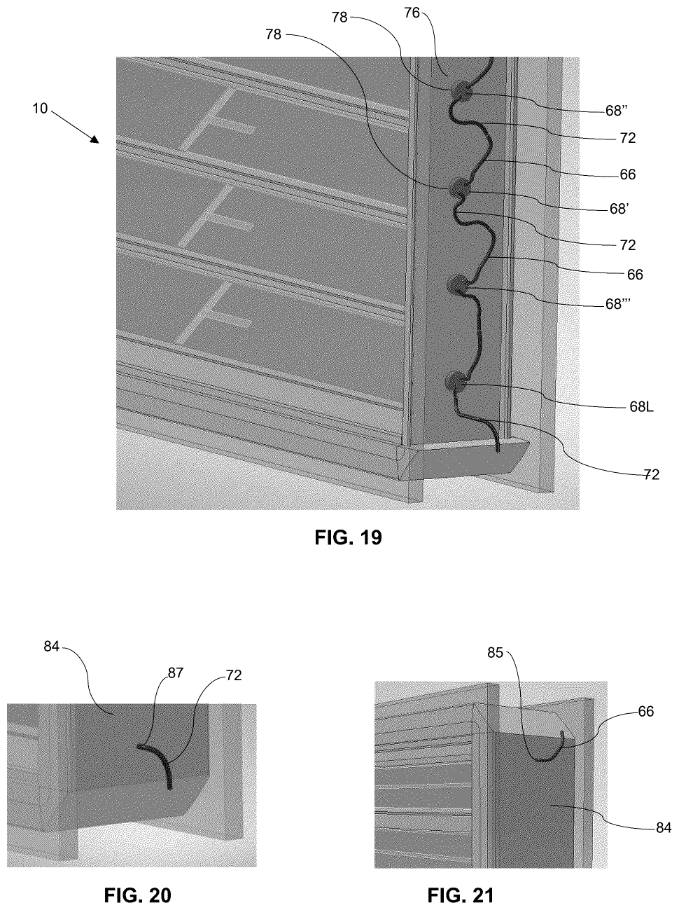

Turning to FIGS. 13 to 20, the lateral member structure 20B (referred to in FIG. 1) comprise an inner panel 76 with openings 78 for the pivot members 68 of each louver structure 26 to pivotally protrude therethrough thereby providing a series 80 of pivot members 68 along the length of the inner panel 76 with the uppermost pivot being the top pivot 68U and the lowermost pivot being bottom pivot 68L The pivots are interconnected via electrical contact between their respective negative and positive wires (66, 72) protruding therefrom. As such, a negative wire 66 of a given pivot member 68′ is connected to the positive wire 72 of the next upper pivot member 68″, whereas the positive wire 72 of this given pivot member 68′ is connected to the positive wire 66 of the next lower pivot member 68′″. As such, the photovoltaic streams 56 of each louver structure 26 are connected in series, denoted here as 82.

The inner panel 76 is capped by an outer panel 84 in order to cover the wire connection series 82. The panel 84 includes a top hole 85 and a bottom hole 87. The positive wire 66 of the uppermost pivot member 68U protrudes through the top hole 85 and the negative wire 72 of the lowermost pivot member 68L protrudes through the bottom hole 87. The wires 66 and 72 are connected to a electrical system for collecting electrical power provided by the cells 40 capturing sunlight. In an embodiment, the wires 66, 72 of one unit 10 are connected to wires 72,66, respectively, of another unit 10 thereby creating PV strings. In an embodiment, these PV strings are connected in parallel forming arrays. This adds the element of expandability.

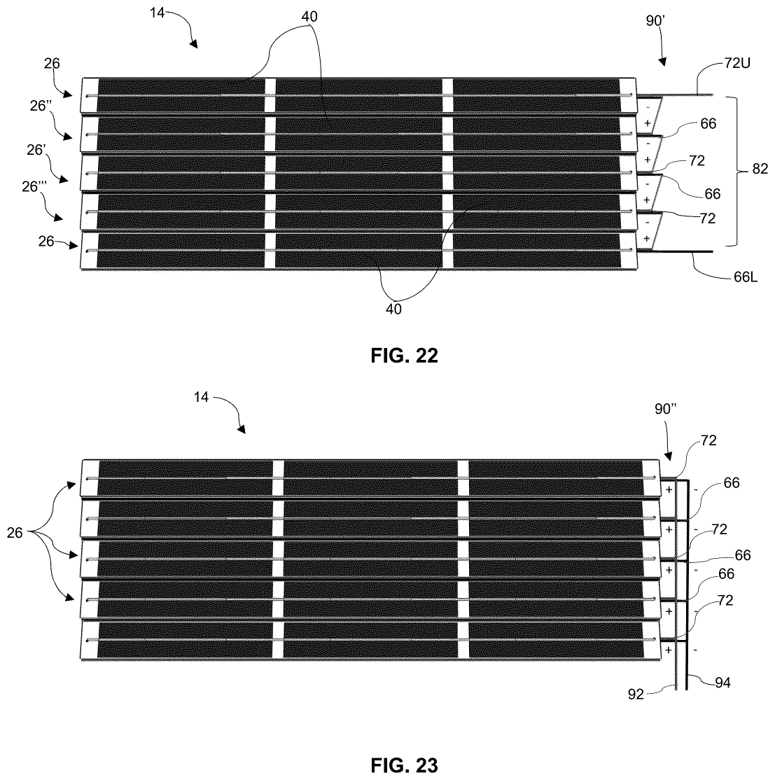

FIG. 22 shows a schematic example of the photovoltaic cells being electrical connected in series, whereas FIG. 23 shows a schematic example of the photovoltaic cells being connected in parallel.

In FIG. 22 there is shown a plurality of horizontal louver structures 26 carrying respective cells 40 with bus bars 42 and contact elements 44 extending along the length L from the gear end 58A to the pivot end 58B. Each louver structure has a negative wire 66 and a positive wire 72 outwardly protruding from their pivot end 58B to be in electrical communication with an electric circuit load 90′. In this example, the electric circuit load 90′ comprises a connection of a positive wire 72 of a given louver structure 26′ to the negative wire 66 of the next upper louver structure 26″, whereas the negative wire 66 of this given louver structure 26′ is connected to the positive wire 72 of the next lower louver structure 26′″. As such, the photovoltaic streams 56 of each louver structure 26 are connected in series, denoted here as 82 and forming part of the electrical circuit load 90′. The electrical circuit load 90′ comprises an uppermost positive wire 72U and a lowermost negative wire 66L which are in electrical communication with an electrical system.

In FIG. 23 there is shown a plurality of horizontal louver structures 26 carrying respective cells 40 with bus bars 42 and contact elements 44 extending along the length L from the gear end 58A to the pivot end 58B. Each louver structure 26 has a negative wire 66 and a positive wire 72 outwardly protruding from their pivot end 58B to be in electrical communication with an electric circuit load 90″. In this example, the electric circuit load 90′ comprises the negative wires 66 of each of the louver structures 26 being connected to a common negative wire 92 and the positive wires 72 of each of the louver structures being connected a common positive wire 94. The common positive wire 92 and the common negative wire 96 are in are in electrical communication with an electrical system.

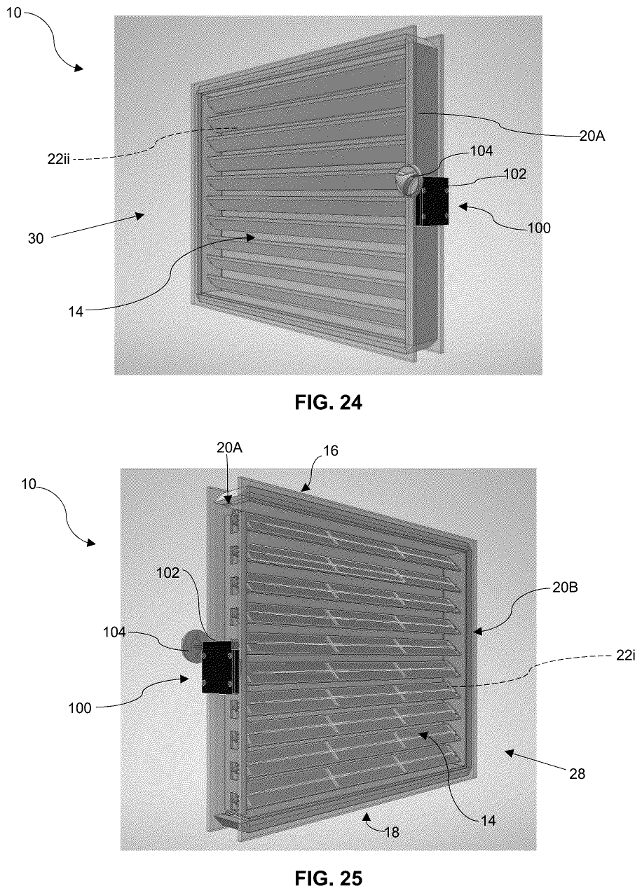

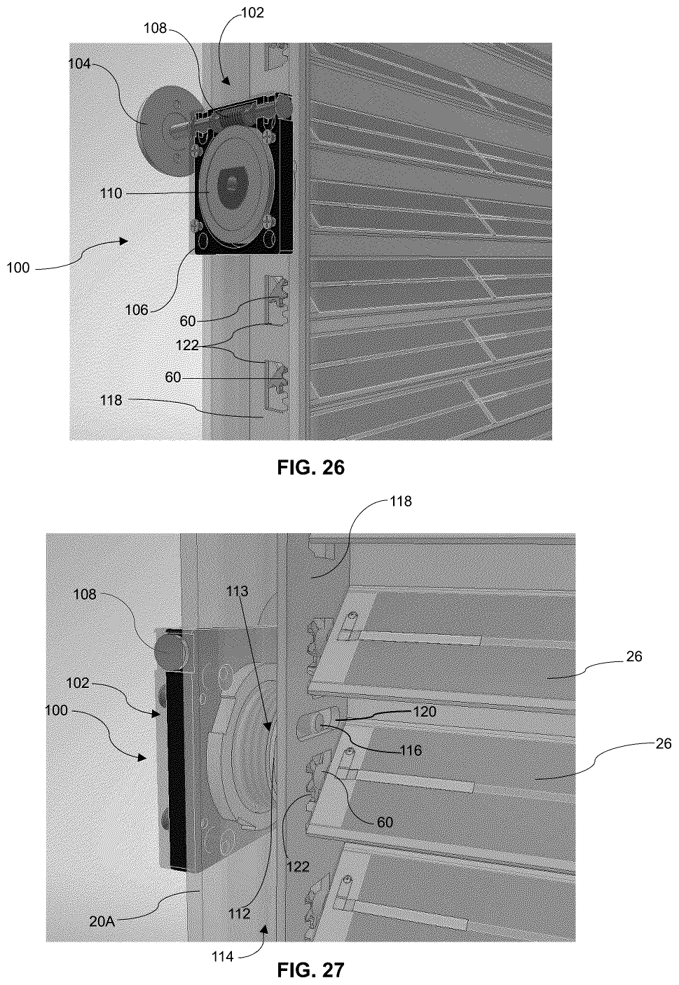

With reference to FIGS. 24 to 27, the actuator assembly 100 of the double glazed window 10 will now be described in accordance with a non-restrictive illustrative embodiment of the present disclosure.

The double-glazed window unit 10 includes the frame 12 with a louver blind comprising top and bottom members 16 and 18, respectively, and the opposite lateral members 20A and 20B. The first window panel 22i is an outer window panel and the second window panel 22ii is an inner window panel. The louver structures 26 are shown positioned between the window panels 22i and 22ii which are mounted to the frame 12.

The actuator assembly 100 is mounted to the frame lateral member 20A and comprises a gear assembly 102 actuated by a manual operator 104 or via automated control as is known in the art. The gear assembly 102 comprises a housing 106 with a top worm gear 108 rotated by the manual operator 104 to engage a central gear 110 with an inner part 112 protruding through an opening 113 in the lateral member 20A into a lateral channel 114 and having an inwardly protruding tab 116 that engages longitudinal flat body 118. The flat body 118 defines a horizontal slot 120 for receiving the tab 116. As the tab 116 rotates along with the inner part 112, it reciprocally moves the flat body 118 via the slot 120 upwardly and downwardly within the channel 114. The flat body 118 defines cut-outs 122 engaging the pivot gears of each of the louver structure 26 thereby imparting a pivot movement thereto.

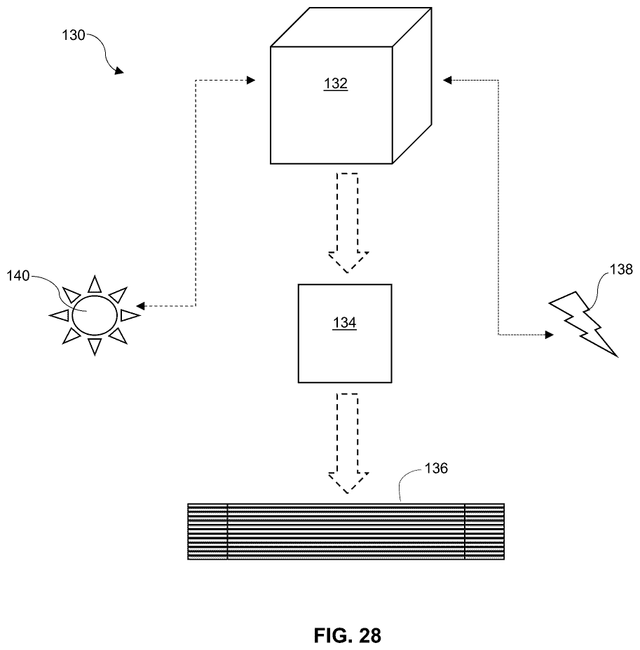

Turning to FIG. 28, there is shown a system 130 for monitoring and controlling a photovoltaic louver blind structure comprising a system controller 132 such as a processor or a microprocessor with a memory of processor executable code that when executed provides the controller to execute computer implementable steps as defined herein. The controller 132 is in operative communication with the actuator assembly 134 which actuate the pivoting or rotation of the photovoltaic louver blind structure 136. The controller 132 is also in operative communication with an electrical output sensor 138 which determines the electrical output of the photovoltaic louver blind structure 136. The controller 132 receives electrical output data from the sensor 138 and, based on the data and electrical output criteria stored in the controller memory, controls the actuator assembly 134 to rotate the photovoltaic louver blind structure 136 such as to optimize light capture thereof in accordance with the electrical output criteria. In an embodiment, a light capturing sensor 140 is in operative communication with the photovoltaic louver blind structure 136 and with the controller 132. The sensor 140 provides light capturing data to the controller 132 related to how much light is captured by the photovoltaic louver blind structure 136. The controller 132 receives this light capturing data from the sensor 140 and, based on this data and light capturing criteria stored in the controller memory, controls the actuator assembly 134 to rotate the photovoltaic louver blind structure 136 such as to optimize light capture thereof in accordance with the light capturing data. In an embodiment, the controller 132 receives data from both sensors 138 and 140 and controls the actuator assembly 132 to rotate the photovoltaic louver blind structure 136 based on predetermined light capturing and electrical output criteria stored in the controller memory.

The various features described herein can be combined in a variety of ways within the context of the present disclosure so as to provide still other embodiments. As such, the embodiments are not mutually exclusive. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

What is claimed is:

1. A louver-blind double glazed window unit comprising:
a frame structure defining first and second faces of the unit, and outer side and inner sides;
a first window mounted to the first face of the unit and a second window mounted to the second face of the unit,
an inner chamber defined between the frame structure and the first and second windows;
a plurality of adjacent louver structures longitudinally extending within the chamber and pivotally mounted to a longitudinal part of the frame structure, each one of the louver structures comprising:
a longitudinal louver member defining a length thereof, a top side, an underside, an inner channel therebetween and a pair of opposite longitudinal ends, each of the pair of opposite longitudinal ends respectively defining a gear end and a pivot end, the longitudinal louver member comprises a pivot member at the pivot end pivotally mounted to the longitudinal part of the frame structure, the pivot member defining a pivot channel therethrough and pivot openings;
a photovoltaic cell stream mounted to the top side of the louver member and comprising longitudinal a bus bar stream longitudinally extending along the length of the longitudinal louver member; and
an electrical circuit in electrical communication with the photovoltaic cell stream, the electrical circuit comprising:
a positive contact member mounted at one of the opposite longitudinal ends onto the photovoltaic cell stream and being in contact with a positive wire positioned within the longitudinal louver member channel via an opening in the top side of the longitudinal louver member, the positive wire being fitted within the pivot channel and protruding outwardly therefrom via one of the pivot openings to be in electrical communication with an electrical load circuit; and
a negative contact member mounted at another of the opposite longitudinal ends onto the photovoltaic cell stream and being in contact with a negative wire positioned within the longitudinal louver member channel via an opening in the top side of the longitudinal louver member, the negative wire member being fitted within the pivot channel and protruding outwardly therefrom via one of the pivot openings to be in electrical communication with an electrical load circuit; and
an actuator assembly in operative communication with the plurality of louver members at the gear ends thereof for selectively imparting a pivot movement thereto between open and closed positions thereof.

2. A louver-blind double glazed window according to claim 1, wherein a given one of the pivot members is positioned between a first and second adjacent ones of the pivot members along the longitudinal part of the frame structure, the negative wire protruding through the given one of the pivot members is connected to the positive wire protruding through the first adjacent one of the pivot members and the positive wire protruding through the given one of the pivot members is connected to the negative wire protruding through the second adjacent one of the pivot members.

3. A louver-blind double glazed window according to claim 1, wherein the negative wires protruding through the pivot members are connected to a same common negative wire and wherein the positive wires protruding through the pivot members are connected to a same common positive negative wire.

4. A louver-blind double glazed window according to claim 1, wherein the photovoltaic cell stream comprises a series of photovoltaic cells arranged along their length on the top side of each of the louver members and being spaced apart so as to define gaps therebetween, wherein the longitudinal bus bar stream comprises a bus bar on each top and bottom surface of each photovoltaic cell, wherein the bus bar at the top side of one of the photovoltaic cells is connected to the bus bar at the bottom side of an adjacent one of the photovoltaic cells via a contact member extending through the gap therebetween.

5. A louver-blind double glazed window according to claim 1, wherein the actuation assembly comprises a gear assembly mounted to the frame with an inwardly protruding member engaging an inner flat member engaging louver gears for imparting the pivot movement thereto between open and closed positions thereof.

6. A louver-blind double glazed window according to claim 1, wherein the actuation assembly is manually controlled or motorized.

7. A louver-blind double glazed window according to claim 1, further comprising a controller in operative communication with the actuation assembly for control thereof.

8. A louver-blind double glazed window according to claim 7, further comprising a sensor for detecting electrical output of the electrical circuit load and being in operative communication with the controller to provide electrical output data thereto, the controller having an associated memory of computer executable code for implementing computer steps of controlling the actuation assembly based on the electrical output data.

9. A louver-blind double glazed window according to claim 7, further comprising a sensor for detecting light capturing performance of the photovoltaic stream and electrical and being in operative communication with the controller to provide capturing performance thereto, the controller having an associated memory of computer executable code for implementing computer steps of controlling the actuation assembly based on the capturing performance data.

10. A louver-blind structure for a double-glazed window unit comprising a frame structure defining first and second faces of the unit, and outer side and inner sides, a first window mounted to the first face of the unit and a second window mounted to the second face of the unit; and an inner chamber defined between the frame structure and the first and second windows, the louver-blind structure comprising:
a plurality of adjacent louver structures longitudinally extending within the chamber and pivotally mounted to a longitudinal part of the frame structure, each one of the louver structures comprising:
a longitudinal louver member defining a length thereof, a top side, an underside, an inner channel therebetween and a pair of opposite longitudinal ends, each of the pair of opposite longitudinal ends respectively defining a gear end and a pivot end, the longitudinal louver member comprises a pivot member at the pivot end pivotally mounted to the longitudinal part of the frame structure, the pivot member defining a pivot channel therethrough and pivot openings;
a photovoltaic cell stream mounted to the top side of the louver member and comprising longitudinal a bus bar stream longitudinally extending along the length of the longitudinal louver member; and
an electrical circuit in electrical communication with the photovoltaic cell stream, the electrical circuit comprising:
a positive contact member mounted at one of the opposite longitudinal ends onto the photovoltaic cell stream and being in contact with a positive wire positioned within the longitudinal louver member channel via an opening in the top side of the longitudinal louver member, the positive wire being fitted within the pivot channel and protruding outwardly therefrom via one of the pivot openings to be in electrical communication with an electrical load circuit; and
a negative contact member mounted at another of the opposite longitudinal ends onto the photovoltaic cell stream and being in contact with a negative wire positioned within the longitudinal louver member channel via an opening in the top side of the longitudinal louver member, the negative wire member being fitted within the pivot channel and protruding outwardly therefrom via one of the pivot openings to be in electrical communication with an electrical load circuit; and
an actuator assembly in operative communication with the plurality of louver members at the gear ends thereof for selectively imparting a pivot movement thereto between open and closed positions thereof.

11. A louver-blind structure according to claim 10, wherein a given one of the pivot members is positioned between a first and second adjacent ones of the pivot members along the longitudinal part of the frame structure, the negative wire protruding through the given one of the pivot members is connected to the positive wire protruding through the first adjacent one of the pivot members and the positive wire protruding through the given one of the pivot members is connected to the negative wire protruding through the second adjacent one of the pivot members.

12. A louver-blind double glazed window according to claim 10, wherein the negative wires protruding through the pivot members are connected to a same common negative wire and wherein the positive wires protruding through the pivot members are connected to a same common positive negative wire.

13. A louver-blind structure according to claim 10, wherein the photovoltaic cell stream comprises a series of photovoltaic cells arranged along their length on the top side of each of the louver members and being spaced apart so as to define gaps therebetween, wherein the longitudinal bus bar stream comprises a bus bar on each top and bottom surface of each photovoltaic cell, wherein the bus bar at the top side of one of the photovoltaic cells is connected to the bus bar at the bottom side of an adjacent one of the photovoltaic cells via a contact member extending through the gap therebetween.

14. A louver-blind structure according to claim 10, wherein the actuation assembly comprises a gear assembly mounted to the frame with an inwardly protruding member engaging an inner flat member engaging louver gears for imparting the pivot movement thereto between open and closed positions thereof.

15. A louver-blind structure according to claim 10, wherein the actuation assembly is manually controlled or motorized.

16. A louver-blind structure according to claim 10, further comprising a controller in operative communication with the actuation assembly for control thereof.

17. A louver-blind structure according to claim 16, further comprising a sensor for detecting electrical output of the electrical circuit load and being in operative communication with the controller to provide electrical output data thereto, the controller having an associated memory of computer executable code for implementing computer steps of controlling the actuation assembly based on the electrical output data.

18. A louver-blind structure according to claim 16, further comprising a sensor for detecting light capturing performance of the photovoltaic stream and electrical and being in operative communication with the controller to provide capturing performance thereto, the controller having an associated memory of computer executable code for implementing computer steps of controlling the actuation assembly based on the capturing performance data.
